(19) United States
(12) Patent Application Publication
(10) Pub. No.: US 2014/0108572 A1
(43) Pub. Date: Apr. 17, 2014

(54) MULTI-VARIANT E-MAIL TESTING

(71) Applicant: Experimently, LLC, Murray, UT (US)

(72) Inventors: James Borzilleri, Sandy, UT (US); Kevin Irving, Cottonwood Heights, UT (US)

(73) Assignee: Experimently, LLC, Murray, UT (US)

(21) Appl. No.: 14/052,893

(22) Filed: Oct. 14, 2013

Related U.S. Application Data
(60) Provisional application No. 61/714,074, filed on Oct. 15, 2012.

(51) Int. Cl. H04L 12/58

(52) U.S. Cl. CPC H04L 51/00
USPC 709/206

(57) ABSTRACT

An email campaign management system includes an HTML engine, an image gateway, and an activity monitor. The HTML engine receives input email content and generates modified email content from the input email content. The modified email content includes at least one image location. The image gateway dynamically associates an image with the image location at a time that an email message inclusive of the image location is opened by a recipient. The activity monitor tracks a user selection of a hyperlink within the email message inclusive of the image location and the associated image.

### BACKGROUND

Many companies implement email campaigns to advertise products and services to customers and prospects. The types of advertising emails that are used in email campaigns often include multiple components such as text, images, hyperlinks, animations, and so forth. When these advertising emails are designed and generated, it can be very difficult to anticipate which combination of components might be the most effective with potential customers, or segments of potential customers.

### BRIEF DESCRIPTION OF THE DRAWINGS

FIG. 1 depicts a schematic diagram of one embodiment of a multivariate email campaign system.

FIG. 2A depicts a schematic diagram of one embodiment of the campaign manager of FIG. 1.

FIG. 2B depicts a schematic diagram of one embodiment of an email message template for the modified HTML output by the HTML engine of FIG. 2A.

FIG. 3 depicts a flow chart diagram of one embodiment of a method for creating dynamic images in static HTML.

FIG. 4 depicts a flow chart diagram of one embodiment of a method for creating static variations in variable HTML.

FIG. 5 depicts a flow chart diagram of one embodiment of a method for client/server interaction on experiment run time for the static HTML method of FIG. 3.

FIG. 6 depicts a flow chart diagram of one embodiment of a method for client/server interaction on experiment run time for the variable HTML method of FIG. 4.

FIG. 7 depicts a flow chart diagram of one embodiment of a method for picking a combination of images.

FIG. 8 depicts a flow chart diagram of one embodiment of a method for generating modified static HTML with variable images.

FIG. 9 depicts a flow chart diagram of one embodiment of a method for generating modified variable HTML with static variations.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments.

One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate multivariate testing of email image content by dynamically populating combinations of images at the time that a user opens a received email. The use of images as part of the email content allows the images to be dynamically selected and inserted into the email at the time that the user opens and views the email. The ability to perform multivariate testing on various combinations of images within an opened email can provide very useful marketing feedback to the sender of the email. By gathering data on the effectiveness of various images and/or image combinations, an email campaign manager may dynamically tailor which email images are displayed in other emails that will be sent out in the future. Additionally, the email campaign manager may dynamically tailor which email images are displayed in other emails that have already been sent out, but which have not yet been opened by the recipients. In other embodiments, the email campaign manager may dynamically change which email images are displayed in an email which has been previously opened and is subsequently reopened by the same recipient. Other embodiments may facilitate additional benefits as described herein. For example, in another embodiment the images or text within a specific email may be decided individually per email recipient.

Text and/or text variations are references to different possibilities of HTML within an email message. These may include textual content of an email message, styling changes (e.g., color, size, font, etc.), or layout changes (e.g., position, block size, padding, margins, etc.).

Embodiments described herein make it possible to statistically quantify the effectiveness of particular images, text, and/or combinations thereof in email advertisements. In some embodiments, the most effective components may be determined for a particular target market segment.

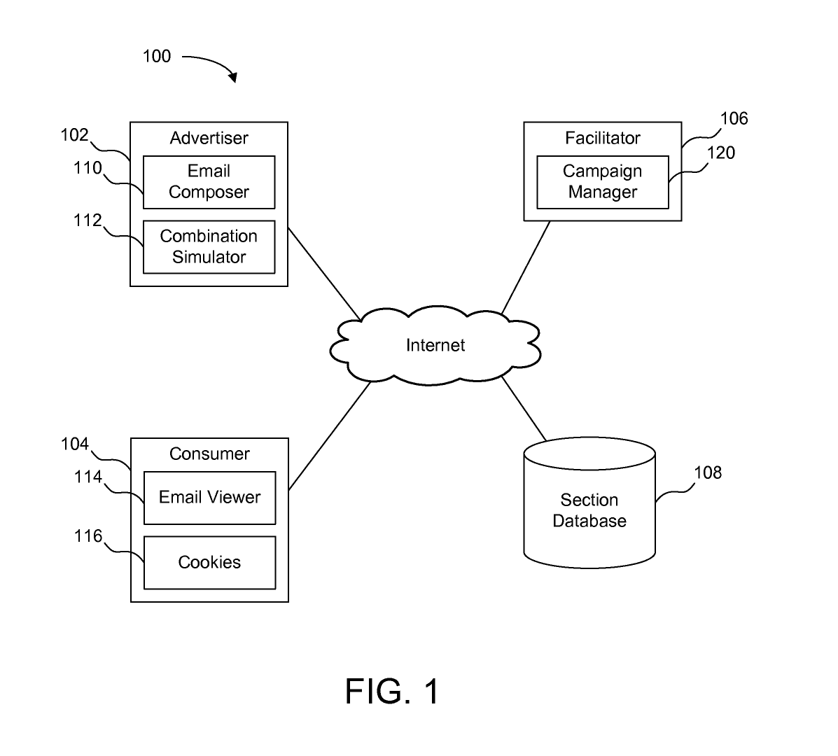

FIG. 1 depicts a schematic diagram of one embodiment of a multivariate email campaign system 100. The illustrated campaign system 100 includes an advertiser 102, a consumer 104, and a facilitator 106. The campaign system 100 also includes a section database 108. Although the campaign system 100 is shown and described with various components and functionality, some embodiments of the campaign system 100 may included fewer or more components to implement less or more functionality.

In one embodiment, the advertiser 102 is a computer system to initiate an advertising campaign. The advertiser 102 may be under the control of one or more entities, which are involved in the sale of goods and/or services, or in the development of online marketing strategies. The illustrated advertiser 102 includes an email composer 110 and a combination simulator 112. The email composer 110 and the combination simulator 112 may be implemented locally on the advertiser 102 or, alternatively, may be partially or fully implemented on a remote system component (e.g., at the facilitator 106) and made available via a web browser at the advertiser 102.

In one embodiment, the email composer 110 allows a user to input content such as text, images, and so forth for a potential email to be delivered to the consumer as part of an email marketing campaign. Additionally, the email composer 110 may allow a user to select one or more images to include in the composed email. The email composer 110 also may have functionality to arrange various content fields such as the text and image(s) in different compositional arrangements. For example, images may be arranged to be in header, sidebar, or footer locations within a particular email. In another example, images may be arranged to be in a central body location, or superimposed over another element or portion of the email content.

In one embodiment, the email composer 110 allows the user to designate multiple potential images for use in a single section, or location, within a particular email message. For example, the user may select two, three, four, or more images that each may be used in the footer location of separate emails. Similarly, the user may designate the same number or a different number of potential images for use in another section of the same email message. The designation of different groups of images that may be used in different sections of the same email message results in a plurality of unique combinations of images and/or image locations based on a common set of potential content. A similar approach may be implemented for text or other types of content, in addition to images.

In one example, the user may use the email composer 110 to generate an email template with one text section and three image sections. In one embodiment, the image sections are defined by cascading style sheet (CSS) selectors. For convenience, the email template also may be referred to as a dynamic email.

The text may be input into the email composer directly by the user. Alternatively, the text may be dynamically selected from one of multiple possible text statements at the time that the email is generated and sent to the recipients. Dynamically selected text may be input into one or more corresponding text sections of the email message.

Each of the image sections may have a corresponding set of images. For example, the first image section may have a corresponding set of three images: A1, A2, and A3; the second image section may have a corresponding set of two images: B1 and B2; and the third image section may have a corresponding set of four images: C1, C2, C3, and C4. Each set of images may be used to dynamically populate the corresponding image section within the email content at the time that a recipient opens the received email. Also, email messages opened by different recipients may be populated with different images and/or image combinations. Thus, unlike the text content which is selected before the email is sent and remains static thereafter, the potential image content may be identified before or after the email is sent. Moreover, individual images may be selected from one or more sets of potential images and displayed at the time that an email message is opened. For example, the email message for a recipient may be dynamically populated with images A2, B1, and C4, while the email message for another recipient may be dynamically populated within images A1, B1, and C2. In this way, a single dynamic email message may be generated and sent to multiple recipients, but the content which each recipient views may be different based on how the images are dynamically populated when each recipient opens his or her received email message.

In one embodiment, the combination simulator 112 allows the user to generate views of the various combinations of text, images, and so forth, prior to sending out an email message with corresponding text and image locations. In other words, the combination simulator 112 allows the user who is generating the dynamic email message to see different combinations of text, images, and/or other content and authorize which combinations are permissible or impermissible for a particular email marketing campaign and/or target market segment. Alternatively, the individual or combined authorizations may be input by the user on a separate reporting page or other location within the system.

The following table illustrates one example of possible image combinations that are authorized or prohibited. In this example, each possible combination is identified by a unique combination identifier. Five of the possible combinations are prohibited, while the remaining nineteen possible combinations are authorized. Showing all twenty-four possible combinations in the combination simulator 112 (or on the report page or other location) may help a user to identify and designate which combinations are authorized for use together, and which combinations are prohibited. In further embodiments, this type of authorization may be specifically related to a particular target market segment or other classifying parameter. The overall set of combinations also may have a unique identifier, referred to herein as a set identifier. This set may represent an experiment to determine the effectiveness of a combination of images, so the set identifier also may be referred to as an experiment or experiment identifier.

TABLE 1
Sample list of authorized and prohibited image combinations.

| Combination | Image in | Image in | Image in | |
|---|---|---|---|---|
| ID | Section #1 | Section #2 | Section #3 | Authorization |
| 1 | A1 | B1 | C1 | Yes |
| 2 | A1 | B1 | C2 | Yes |
| 3 | A1 | B1 | C3 | Yes |
| 4 | A1 | B1 | C4 | Yes |
| 5 | A1 | B2 | C1 | Yes |
| 6 | A1 | B2 | C2 | NO |
| 7 | A1 | B2 | C3 | Yes |
| 8 | A1 | B2 | C4 | Yes |
| 9 | A2 | B1 | C1 | Yes |
| 10 | A2 | B1 | C2 | Yes |
| 11 | A2 | B1 | C3 | Yes |
| 12 | A2 | B1 | C4 | Yes |
| 13 | A2 | B2 | C1 | NO |
| 14 | A2 | B2 | C2 | NO |
| 15 | A2 | B2 | C3 | NO |
| 16 | A2 | B2 | C4 | NO |
| 17 | A3 | B1 | C1 | Yes |
| 18 | A3 | B1 | C2 | Yes |
| 19 | A3 | B1 | C3 | Yes |
| 20 | A3 | B1 | C4 | Yes |
| 21 | A3 | B2 | C1 | Yes |
| 22 | A3 | B2 | C2 | Yes |
| 23 | A3 | B2 | C3 | Yes |
| 24 | A3 | B2 | C4 | Yes |

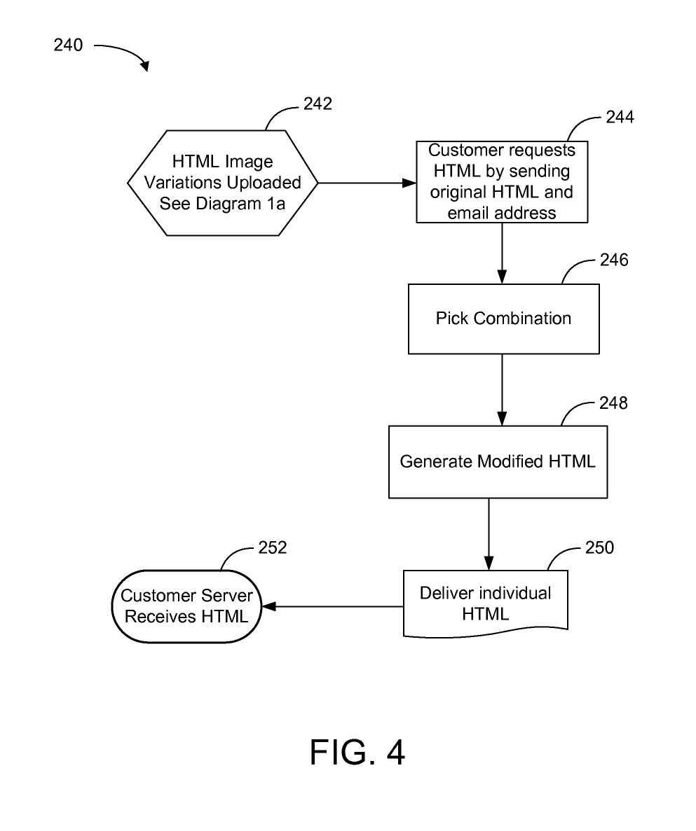

In another embodiment, a first image section may have a corresponding set of three images: A1, A2, and A3; a second image section may have a corresponding set of two images: B1 and B2; and a text section may have a corresponding set of four of text variations: T1, T2, T3, and T4. Since text becomes static once the email message is delivered to the recipient, the method 240 shown in FIG. 4 and described in more detail below may be used to change text prior to transmission of the email message.

The following Table 2 illustrates one example of possible image combinations that are authorized or prohibited. In this example, each possible combination is identified by a unique combination identifier. Six of the possible combinations are prohibited, while the remaining eighteen possible combinations are authorized. Showing all twenty-four possible combinations in the combination simulator 112 (or on the report page or other location) may help a user to identify and designate which combinations of images and text are authorized for use together, and which combinations are prohibited. In further embodiments, this type of authorization may be specifically related to a particular target market segment or other classifying parameter. As mentioned above, the overall set of combinations also may have a unique set identifier, experiment, or experiment identifier.

TABLE 2
Sample list of authorized and prohibited
image and text combinations.

| Combination | Image in | Image in | Text in | |
|---|---|---|---|---|
| ID | Section #1 | Section #2 | Section #3 | Authorization |
| 1 | A1 | B1 | T1 | Yes |
| 2 | A1 | B1 | T2 | Yes |
| 3 | A1 | B1 | T3 | Yes |
| 4 | A1 | B1 | T4 | Yes |
| 5 | A1 | B2 | T1 | Yes |
| 6 | A1 | B2 | T2 | Yes |
| 7 | A1 | B2 | T3 | Yes |
| 8 | A1 | B2 | T4 | Yes |
| 9 | A2 | B1 | T1 | Yes |
| 10 | A2 | B1 | T2 | NO |
| 11 | A2 | B1 | T3 | NO |
| 12 | A2 | B1 | T4 | NO |
| 13 | A2 | B2 | T1 | Yes |
| 14 | A2 | B2 | T2 | Yes |
| 15 | A2 | B2 | T3 | Yes |
| 16 | A2 | B2 | T4 | Yes |
| 17 | A3 | B1 | T1 | Yes |
| 18 | A3 | B1 | T2 | Yes |
| 19 | A3 | B1 | T3 | Yes |
| 20 | A3 | B1 | T4 | Yes |
| 21 | A3 | B2 | T1 | NO |
| 22 | A3 | B2 | T2 | Yes |
| 23 | A3 | B2 | T3 | NO |
| 24 | A3 | B2 | T4 | NO |

In one embodiment, the section database 108 stores some or all of the possible images or text variations for use with a particular email campaign. The section database 108 may be a separate database, as shown in FIG. 1. Alternatively, the section database 108 may be coupled to and/or integrated with the advertiser 102 and/or the facilitator 106. In one embodiment, the images or text variations are uploaded by the clients to a hosted database which is managed by the same administrator as the facilitator 106. In another embodiment, the images are hosted at another location, either by the clients or by a third party hosting service, and the facilitator 106 maintains a list of addresses such as universal resource locators (URLs) that point directly to the remotely stored images. In some embodiments, the section database 108 also stores and maintains these URLs. The section database 108 also may store section information to identify which sections, or locations, are possible for each image or text variation, as well as combination information to identify which combinations of variations are authorized and/or prohibited.

In one embodiment, the consumer 104 is a computer system that receives an advertising email from the advertiser 102. The illustrated consumer 104 includes an email viewer 114 and one or more cookies 116. The email viewer 114 may be any type of viewer, whether implemented locally at the consumer 104 or via a browser from a remote email server (e.g., web mail). Many conventional email viewers show certain parameters of received emails in a list view prior to showing the content that is included with the received emails. For example, many email viewers will show the name and/or email address of a sender, as well as a subject line for the received email. Once a user previews or opens an email, the email viewer may automatically download images that are specified in the body content of the received email. Alternatively, the email viewer may require authorization from the viewer prior to downloading and displaying such images. Once a viewer provides such authorization, the consumer 104 may store the location of the image(s) in one or more cookies 116 for future reference. This makes it possible for the email viewer 114 to re-access the same images from the same location without further authorization from the viewer.

Once images are downloaded and viewed within a received email, the consumer 104 stores at least one cookie indicative of the combination of images that was viewed. In one embodiment, the cookie may store a combination ID such as one of the combination IDs shown above in Table 1. Alternatively, the cookie may store individual image IDs along with corresponding image section identifiers. Any combination of identifying information to associate specific images with corresponding image sections will suffice.

In one embodiment, the cookies 116 contain a unique identifier which references previously viewed combinations and other identifiable information such as market segments. As used herein, market segments refer to any demographical data, activity or behavioral data, computer profiles, and/or browser profiles or characteristics. This information can be stored in the viewed combinations database 134, which is discussed below, or in any database at the advertiser 102, any database at the facilitator 106, a local database at the consumer 104, or at a third party hosting service.

In one embodiment, as long as the cookies 116 are stored by the consumer 104, then the same images will be displayed each time the email is viewed. However, if the viewed combination of images is subsequently de-authorized, or if the corresponding cookies 116 are deleted, then the email viewer 114 will view new images, which may result in the same or different images displayed in the reopened email.

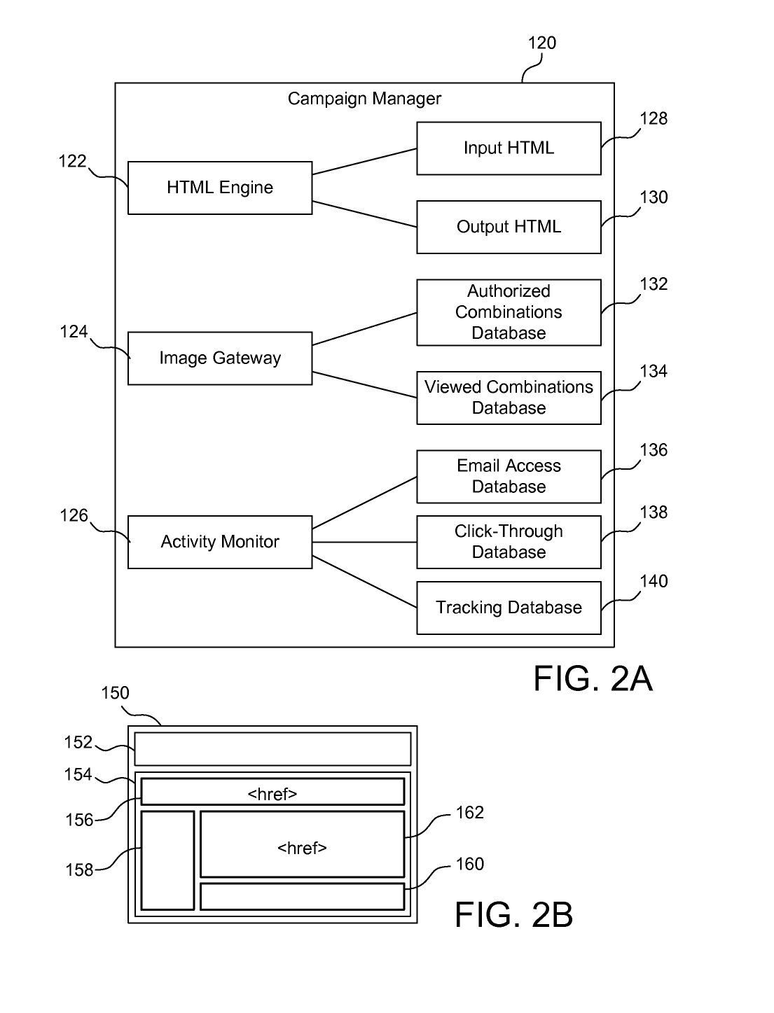

In one embodiment, the facilitator 106 is a computer system to facilitate the dynamic selection and display of email images at the time that the viewer views a received email. The illustrated facilitator 106 includes a campaign manager 120. A specific embodiment of the campaign manager 120 is shown in FIG. 2A and described in more detail below.

In one embodiment, the section database 108 stores some or all of the images or text variations that are selected and displayed in the email messages generated by the advertiser 102 and viewed by the consumer 104. Although the section database 108 is shown in FIG. 1 as a single database independent of other system components, in other embodiments some or all of the images or text variations utilized within the email campaign system 100 may be stored at the advertiser 102, at the consumer 104 (e.g., as a temporary download file), at the facilitator 106, or in another accessible location accessible to the advertiser 102 and the consumer 104.

FIG. 2A depicts a schematic diagram of one embodiment of the campaign manager 120 of FIG. 1. The illustrated campaign manager 120 includes several functional elements which are configured to implement operations related to the management of an email campaign. In one embodiment, the campaign manager 120 includes an HTML engine 122, an image gateway 124, and an activity monitor 126. In one embodiment, all of the components of the campaign manager 120 are hosted and managed by a single system administrator. Other embodiments of the campaign manager 120 may include further functional elements. Additionally, in some embodiments functionality shown and described herein may be distributed among two or more components of the campaign manager 120, or such functionality may be implemented separately from the campaign manager 120.

In one embodiment, the HTML engine 122 receives input HTML 128 from the advertiser 102 and generates output HTML 130 with operational functionality to identify a set of potential images for dynamic selection for display within an email at the time the email is viewed. In other words, the HTML engine 122 modifies the HTML content of an email to make it possible for the email to identify a set of images corresponding to an image location within the content of the email, and to populate that image location with one of the images from the indentified set of images.

In one embodiment, the HTML engine 122 receives the input HTML 128 from the advertiser 102 and generates the output HTML 130 with modified image or text locations individualized for a single target consumer. This makes it possible to identify variations of different text-based sections corresponding to a specific combination.

In one example, a typical HTML image source attribute is provided by the following syntax:
<IMG SRC=”http://www.CM00012764.com/image.gif”>
   where the specified image is located at the indicated universal resource locator (URL), or hyperlink.

In one embodiment, the HTML engine 122 populates the image source attribute of a composed email with a URL which points to a predetermined location of the campaign manager. The image source attribute also may include a location identifier that uniquely identifies an image location within the email, as well as a set identifier that uniquely identifies a set of combinations of images corresponding to the image location tagged with the image source attribute. In this way, when the email is dispatched and subsequently opened by a viewer, the email viewer 114 requests an image from the campaign manager 106, which responds with one of the images associated with the corresponding image location in the email, rather than with a single static image. In one example, the URL specifies the location of the combination of images, rather than the location of a single image, using the following syntax:
<IMG SRC=”http://www.CM00012764.com/combination.htm?locID=A&setID=S1209348”>
   where the specified set of combinations of images is uniquely identifiable from the indicated URL. Alternatively, other embodiments may utilize different combinations of parameters to identify a location and/or set of authorized images. Additionally, in some embodiments, the query string in a particular URL may include additional query parameters. For example, the query string for a particular image source may include one or more image identifiers of other images that are selected for viewing, so that later selected images do not result in an impermissible combination of images. In some embodiments, any identifiers included in the URL may be encrypted or otherwise coded. For example, the set ID “S1209348” may be encrypted or encoded into a substantially longer string of characters. Similarly, any combination IDs, image IDs, other identifiers, commands, or instructions may be encrypted or encoded.

In one embodiment, the campaign manager 120 includes the image gateway 124 to store and access the authorized image combinations in an authorized combinations database 132. Hence, when the consumer 104 accesses a received email message to view the associated content, the consumer 104 may interact with the image gateway 124 of the campaign manager 120 to randomly identify one of the authorized image combinations. The authorized combinations database 132 may store, for example, a table of information such as the data of Table 1 above, or another data set in a different data structure. Alternatively, the information otherwise stored in the authorized combinations database 132 may be stored in the section database 108, as described above.

In a further embodiment, the image gateway 124 also maintains a viewed combinations database 134 to keep track of combinations that have been viewed by specific email recipients. While the use of cookies 116 at the consumer 104 may be sufficient to retain knowledge of the images that have been viewed at the email viewer 114 of the consumer 104, it may be possible to store similar information at the campaign manager 120. Storing this type of information at the campaign manager 120 may ensure that the same images are shown to the same user, even if the user accidentally or purposefully erases the associated cookie(s) 116. Alternatively, storing a history of viewed image combinations may be used to purposefully send different combinations of images to the same user, regardless of the status of cookies 116 at the consumer 104. In one embodiment, the viewed combinations database 134 may store associations between a user ID (e.g., an internet protocol (IP) address, a media access control (MAC) address, an email address, a universal unique identifier (UUID), a global unique identifier (GUID), a randomly generated unique identifier, or a hash of one or more of these and/or similar identifiers) and a combination identifier for a particular combination of viewed images.

In some embodiments, the campaign manager 120 may include further functionality to influence the image/text variations or combinations that are viewed. For example, the authorized combinations database 132 may include randomization or weighting factors which influence the frequency with which certain image/text variations or combinations might be retrieved for viewing by consumers 104.

In further embodiments, the campaign manager 120 may include additional functionality to tailor selected image or text variations to individual consumers based on other characteristics of the consumer profile and/or the email access. For example, additional constraints may be used with one or more combinations depending on the geographical location of the consumer or the relative location of the consumer to one or more localized attractions, events, or venues. As other examples, additional segment constraints may be based on the time zone of the consumer, the time at which the consumer views the email, the type of email client used by the consumer, or any other available consumer profile information or email client characteristics. In some embodiments, this additional functionality is at least partially implemented by the image gateway 124. Alternatively, a separate content gateway (not shown) may implement functionality to control the selection of specific images and/or text variations for individual consumers or groups of consumers.

In one embodiment, the activity monitor 126 maintains one or more databases related to user interactions with a particular email, image, or image combination. For example, the activity monitor 126 may generate and maintain an email access database 136 to track how many times an email has been opened and/or which email recipients have opened an email. In one embodiment, the email access database 136 stores associations between user identifiers and set identifiers, which may be used to uniquely identify a particular email campaign. Alternatively, the email access database 136 may store associations between the user identifiers and other information (e.g., data, viewed combination of images (i.e., combination ID), market segment such as traffic sources, browser types, demographic data, etc.) related to the viewing of an email message. In another example, the activity monitor 126 may generate and maintain a click-through database 138 to track when a hyperlink within the email message is selected by a particular user or by a group of users. In some embodiments, the hyperlink may be directly associated with a particular image. In other embodiments, the hyperlink may be separately accessible independent from an image, even though the hyperlink may be considered associated with a particular image ID or combination ID for a combination of images displayed in a particular email message in which the hyperlink is located. In one embodiment, the click-through database 138 stores associations between user identifiers and variation identifiers and/or combination identifiers. In another example, the activity monitory 126 may generate and maintain a tracking database 140 which stores tracking or reporting information that can be provided to a user for analysis. Various parameters may be tracked within the tracking database 140. In some embodiments, the conversion rate of click-through user selections (versus emails opened and/or emails sent) may be tracked within the tracking database 140. In other words, the tracking database 140 may store the number of emails opened and the number of emails with a click-through, from which a conversion rate may be calculated on-demand.

FIG. 2B depicts a schematic diagram of one embodiment of an email message template 150 for the modified HTML output by the HTML engine 122 of FIG. 2A. The illustrated email message template 150 includes a message header section 152 and a message body section 154. In the message body section 154, there are three image locations 156, 158, and 160, as well as one other section 162 for other message content such as text. In this particular embodiment, the image locations 156, 158, and 160 are generally positioned in typical header, sidebar, and footer locations. However, in other embodiments, there may be fewer or more image or text locations, and the image/text locations may be in other locations anywhere within the message body section.

When an email message is sent to a recipient using this email message template 150, the image locations 156, 158, and 160 may be populated with specific images at the time that the recipient opens the received email message. Also, in the illustrated embodiment, the header image location 154 is associated with a hyperlink (i.e., href). Similarly, the other content section 162 is also associated with a hyperlink (i.e., href). In this way, the recipient may select either the hyperlink of the header image location 156 or the hyperlink of the other content section 162. In response to such a selection, the activity monitor 126 of the campaign manager 120 tracks the selection relative to one or all of the images in the received email message viewed by the recipient. In an embodiment in which the email message template contains a text location, the combination or variations are decided prior to the email message being delivered via the method 240 shown in FIG. 4 and described below.

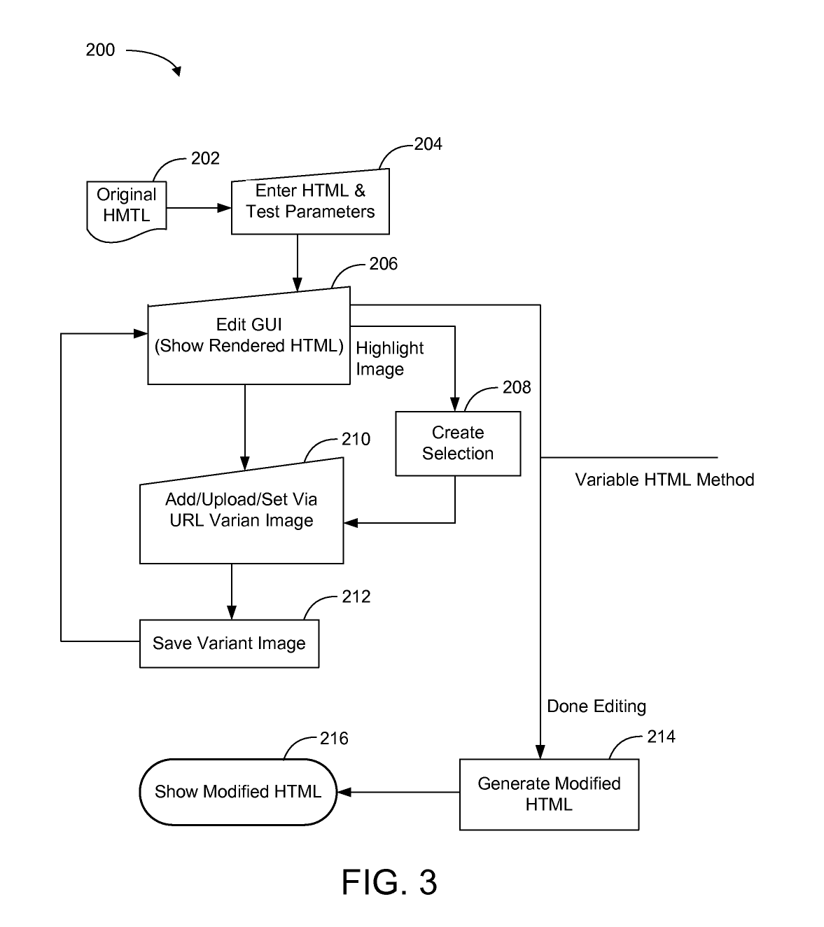

FIG. 3 depicts a flow chart diagram of one embodiment of a method 200 for creating dynamic images in static HTML. In one embodiment, the method 200 generates the modified HTML using a graphic user interface (GUI). In particular, FIG. 3 illustrates operations for creating a single version of modified HTML. While embodiments of the method 200 may be implemented in conjunction with the email campaign system 100 of FIG. 1 and the email composer 110 and/or the campaign manager 120 of FIG. 2A, other embodiments of the method 200 may be implemented with other systems.

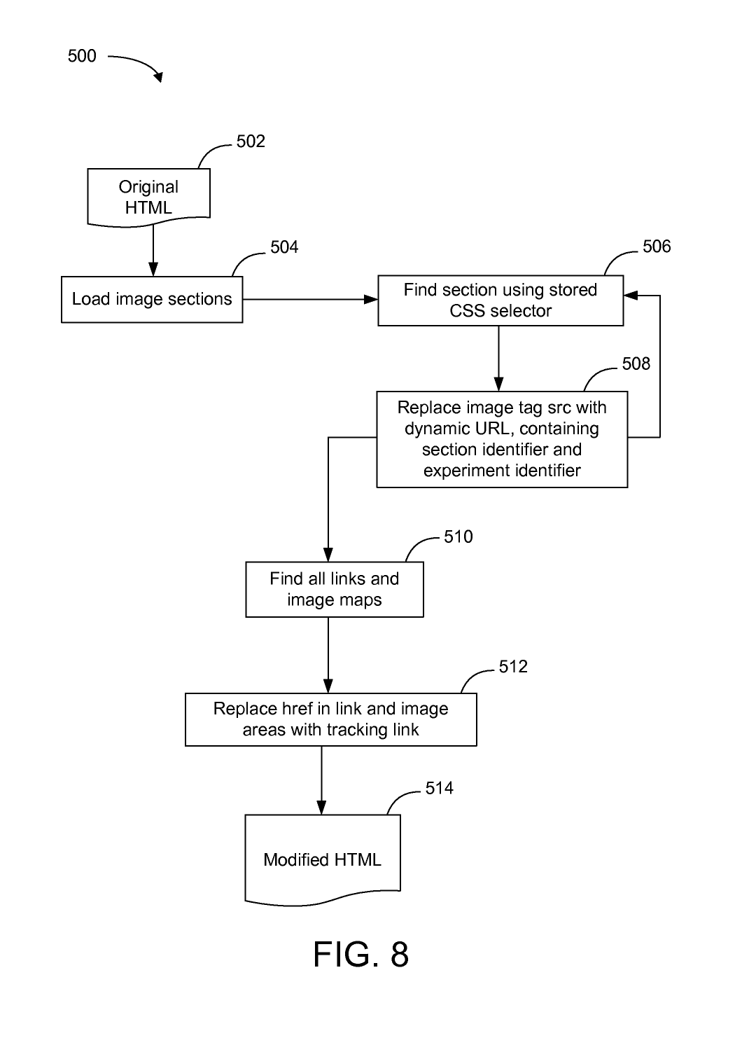

The depicted method 200 begins with availability of the original HTML 202 from the advertiser 102. The original HTML 202 is input 202 into the email composer 110 with one or more test parameters. The advertiser 102 may utilize the combination simulator 112 to view and/or edit 206 rendered versions of the original and/or modified HTML. As needed, the advertiser 102 may create 208 one or more sections in which text, images, or other content may be loaded. In one embodiment, the original HTML 202 is displayed with email sections indicated relative to static content. In another section of the display, or in another window, a user can select 210 (e.g., highlight) an image to be associated with the email message. The advertiser can add the selected image to a list of permissible images for a particular image section. The email composer 110 and/or campaign manager 120 then saves 212 the image (or the image location) for future reference. The advertiser can repeat these operations to identify and store multiple images for different image sections. Once the advertiser is done saving 212 a combination of images, and the editing 206 of a version of the email message is complete, the advertiser can then generate 214 and display 216 the corresponding modified HTML Additional details of an embodiment for generating 214 the modified HTML are provided in FIG. 8 and described in more detail below. The indicated method 200 then ends. Alternatively, prior to generating 214 the modified HTML as described here, the method 200 may branch to the method 240 of FIG. 4 for another approach to generating the modified HTML.

FIG. 4 depicts a flow chart diagram of one embodiment of a method 240 for creating static variations in variable HTML. In one embodiment, the method 240 generates the modified HTML using an individual application program interface (API). While embodiments of the method 240 may be implemented in conjunction with the email campaign system 100 of FIG. 1 and the email composer 110 and/or the campaign manager 120 of FIG. 2A, other embodiments of the method 240 may be implemented with other systems.

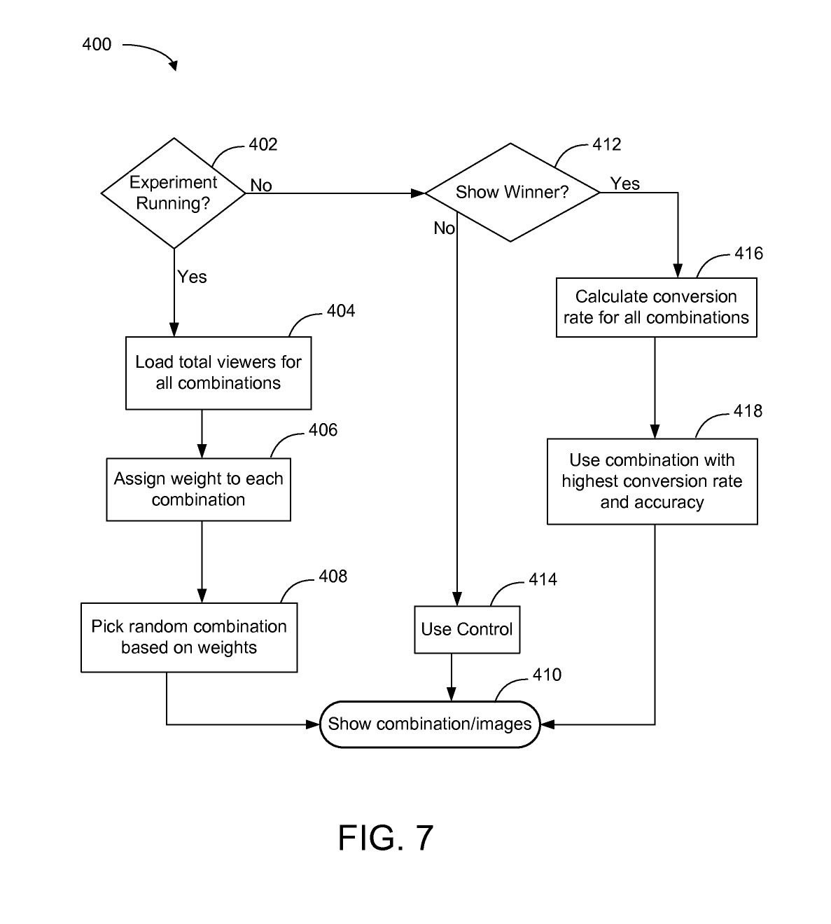

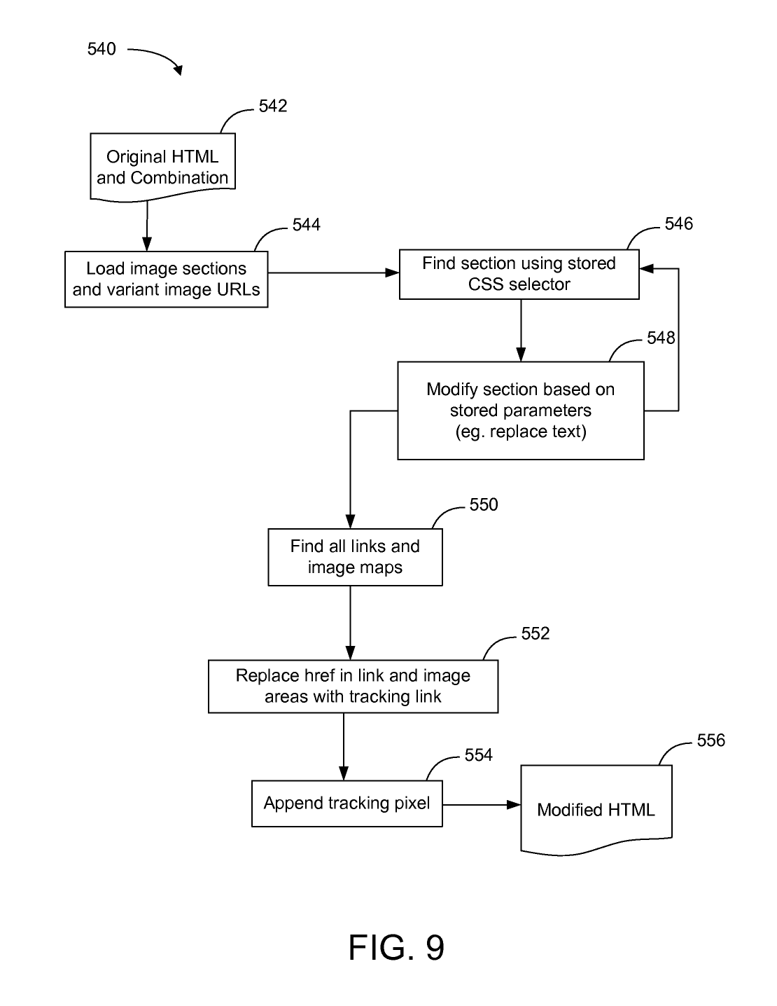

The depicted method 240 begins after the editing operations of FIG. 1 are completed 242 to create multiple email message variants, which are uploaded, for example, to the campaign manager 120. In one embodiment, the campaign manager 120 implements the API to perform the following operations. The API receives 244 a request from the advertiser 102 for modified HTML. The request may include the original HTML 202 and a unique identifier (e.g., email address, hashed email address, randomly generated unique identifier, etc.) representing the target consumer. The API then picks 246 a combination, generates 248 the modified HTML corresponding to the selected combination of images and/or text, and delivers 250 the modified HTML to the requesting advertiser 102, who receives 252 the modified HTML. The manner in which the combination of images and/or text is selected may vary in different embodiments, depending on the type of algorithm (e.g., random, control, winner, etc.) that might be implemented. One example of a method for picking an image combination is shown in FIG. 7 and described in more detail below. The API method may use either of the methods shown in FIG. 8 or 9 for modifying HTML if there are only image-based sections. Additional details of an embodiment for generating 248 the modified HTML with text sections according to the illustrated embodiments are provided in FIG. 9 and described in more detail below.

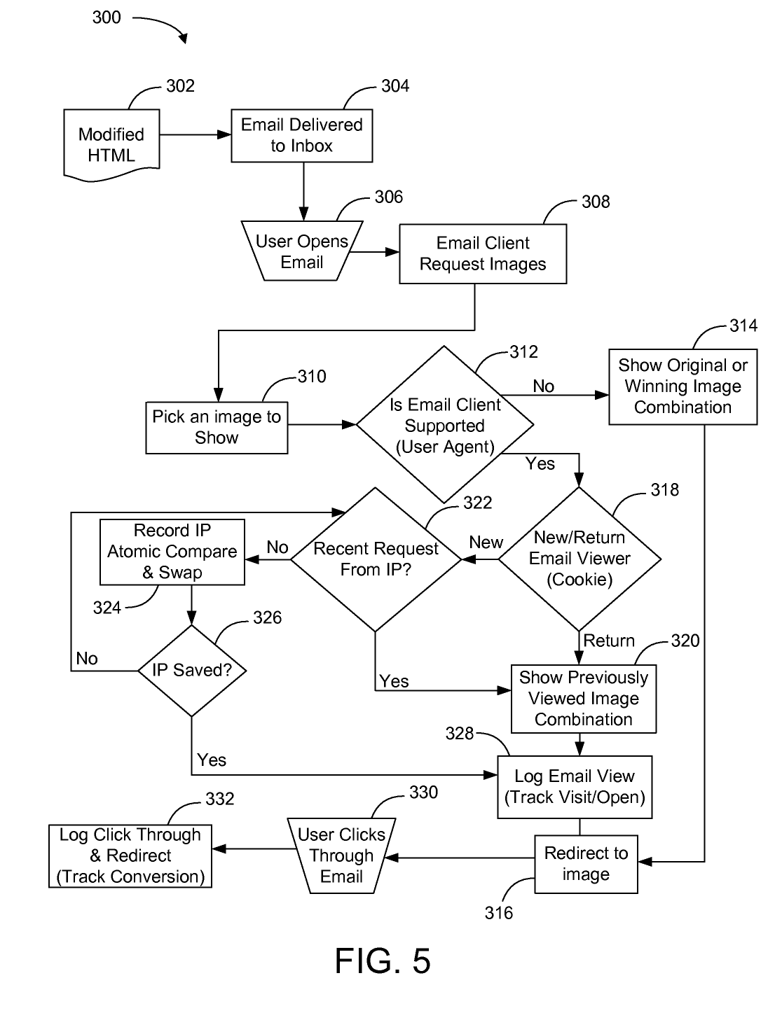

FIG. 5 depicts a flow chart diagram of one embodiment of a method 300 for client/server interaction on experiment run time for the static HTML method of FIG. 3. While embodiments of the method 300 may be implemented in conjunction with the email campaign system 100 of FIG. 1 and the campaign manager 120 of FIG. 2A, other embodiments of the method 300 may be implemented with other systems.

The depicted method 300 begins as the campaign manager 120 provides 302 modified HTML which is capable of dynamically providing various email content images at the time a viewer opens the email message. The email message is then delivered 304 to the inbox of a recipient. When the recipient opens 306 the email message, the email viewer 114 requests 308 associated images from the campaign manager 120, which uses the image gateway 124 to select 310 images from the authorized combinations database 132 to return to the email viewer 114. After an image (or an image combination) is selected 310, a determination is made 312 whether the email viewer is a type of email client that is supported. If not, then the campaign manager 120 instructs 314 the email viewer to show a default image combination such as an original set of images or a winning set of images (discussed further below). The campaign manager 120 then either serves the image directly or redirects 316 the email viewer to the location of the corresponding image(s). This allows the campaign manager 120 to track the visit from this specific request.

Otherwise, if the email viewer is a type of email client that is supported, then the image gateway 124 also references the viewed combinations database 134 to determine 318 if the requesting user (as identified by a user identifier of some sort) has previously requested images associated with this email campaign. If so, then the image gateway 124 may determine which images were previously served to the user and then redirect 320 the user to those images. In this way, the campaign manager 120 instructs 320 the email viewer to show the same image(s) to the recipient. Otherwise, the image gateway 124 may attempt to identify 322 similar requests from the same IP address and, if so, finds the same images and redirects 320 the user accordingly. In one embodiment, the campaign manager 120 determines 322 if this request is from the same location (e.g., IP address) as another recent request based on similar requests that occur within a specified time period (e.g., within the previous 1-10 seconds, 10-30 seconds, 30-90 seconds, and so forth). Otherwise, the campaign manager 120 records 324 the IP address via an atomic compare-and-swap (CAS) function, or any other applicable storage function. In one embodiment, if there are multiple images being pulled in an email, the email client pulls them all at the same time. That means there are no cookies for any of the first image pulls. The CAS operation can be implemented to share the combination between multiple web server threads that are running at the same time so the same combination gets served up to that user. This can be done by associating the user's IP address with the image combination for a very short duration (e.g., 1-10 seconds, 5-30 seconds, 1-30 minutes, <1 day, or another defined or indefinite time period). Without this operation the first pull has the potential to be different from subsequent pulls in multiple email clients/web browsers. Some email clients may function without this CAS operation.

The campaign manager 120 then determines 326 if the IP address is saved through a successful CAS or other storage function operation and, if not, returns to operation 322. Otherwise, if the IP address is saved, then the campaign manager 120 logs 328 an email view to track the number of user visits and/or email opens. The campaign manager also continues with the redirection operations 316.

Additionally, if the user selects 330, or “clicks through,” an image with an associated hyperlink, or another hyperlink within the email message, then the campaign manager 120 logs 332 the selection, and the user is redirected through to the corresponding URL. This allows the campaign manager 120 to track conversions related to specific images, text variations, and/or combinations of images and/or text. The depicted method 160 then ends.

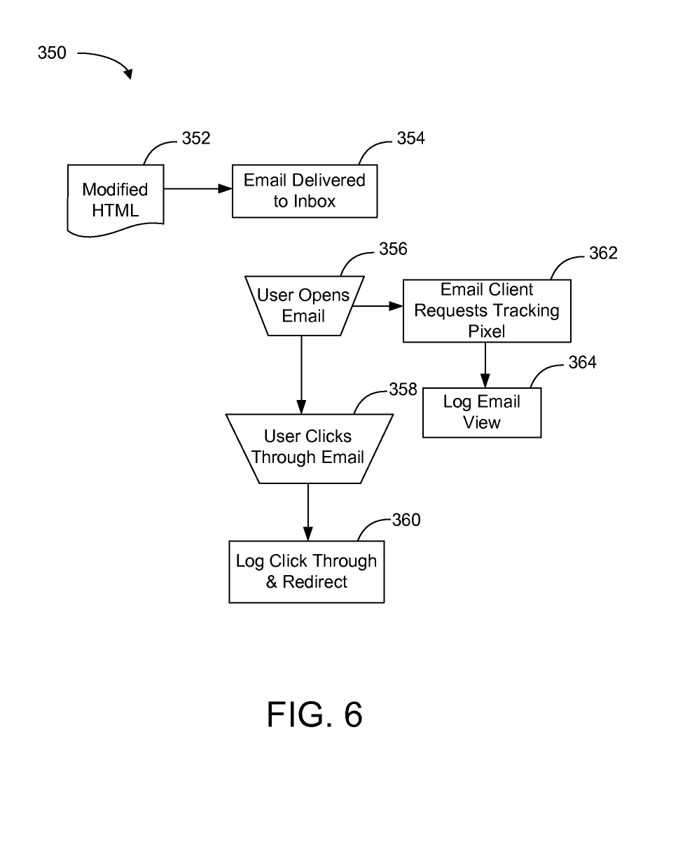

FIG. 6 depicts a flow chart diagram of one embodiment of a method 350 for client/server interaction on experiment run time for the variable HTML method of FIG. 4. While embodiments of the method 350 may be implemented in conjunction with the email campaign system 100 of FIG. 1 and the campaign manager 120 of FIG. 2A, other embodiments of the method 350 may be implemented with other systems.

The depicted method 350 begins as the HTML modified 352 by the campaign manager 120 is delivered 354 to the inbox of a recipient consumer 104. If the consumer 104 does not open and view the email content, then no further action is implemented. However, if the consumer 104 opens 356 the email to view the content, then open event may be reported 362 to the campaign manager 120, which may invoke the activity monitor 126 to update 364 the email access database 136 to reflect the opening of the email, generally. In another embodiment, the activity monitor 126 may be called directly, instead of the campaign manager 120. Also, as explained above, the images within the email are dynamically populated when the email is opened for viewing. If an image has an associated hyperlink, and the viewer also selects 358 the associate hyperlink (e.g., by clicking on the images) or another hyperlink within the email message (by clicking on text or another HTML element with an associated hyperlink), then the campaign manager 120 also invokes the activity monitor 126 to update 360 the click-through database 138 to reflect the selection of the corresponding hyperlink or, alternatively, that the email has received a click-through, generally. Then the user is redirected from the email to the intended location specified by the hyperlink associated with the displayed image. The illustrated method 350 then ends.

FIG. 7 depicts a flow chart diagram of one embodiment of a method 400 for picking a combination of images or text variations. While embodiments of the method 400 may be implemented in conjunction with the email campaign system 100 of FIG. 1 and the campaign manager 120 of FIG. 2A, other embodiments of the method 400 may be implemented with other systems.

In some embodiments, the combination that is used for a particular email message depends on the status of the email campaign. Early in the lifecycle of an email campaign, the combinations may be randomly selected in an attempt to gather data on all of the possible combinations. This stage may be referred to as the experiment stage. Later in the lifecycle of an email campaign, certain combination may be weighted more heavily to facilitate more frequent usage, while still allowing some of the historically less effective combinations to continue to be tested. Ultimately, the email campaign may result in the utilization of only one, or only a relatively small number (e.g., 10% or fewer) of the original possible combinations.

The illustrated method 400 begins with a determination 402 whether an experiment is running. If so, then the campaign manager 120 loads 404 a number of total viewers for all of the possible image combinations. The campaign manager 120 then assigns 406 a weight to each combination. The campaign manager 120 then picks 308 a random combination based on the weighting algorithm and shows 410 (serves or redirects) the selected image combinations.

Alternatively, if the email campaign is not in the experiment stage, then the campaign manager 120 determines 412 if there is a “winning” combination or group of combinations. If not, then a control combination of images and/or text variations is used 414. Otherwise, the campaign manager 120 calculates 416 a conversion rate and uses 418 the combination with the highest conversion rate and/or accuracy. In some embodiments, the selected combination may have the highest conversion rate and/or accuracy for a particular market segment associated with the viewer. The depicted method 400 then ends.

In one embodiment, the campaign manager 120 may influence which combinations are used to find the most effective combination sooner. When all combinations are compared, this is referred to as full-factorial multivariate testing. The campaign manager 120 may implement Taguchi or another similar algorithm (e.g., Genetic algorithms) to try and reach a result more quickly.

In one embodiment, the campaign manager 120 uses a weighted random method to automatically balance the number of email views a specific image combination receives.

In one embodiment, the accuracy of the click-through rate is calculated using the statistical probability that the result is significant. This can be done using the cumulative distribution function of the Chi Square distribution, T distribution, or any other statistical distribution. This can also be calculated using other statistical means (e.g., standard error).

FIG. 8 depicts a flow chart diagram of one embodiment of a method 500 for generating modified static HTML with variable images. While embodiments of the method 500 may be implemented in conjunction with the email campaign system 100 of FIG. 1 and the campaign manager 120 of FIG. 2A, other embodiments of the method 500 may be implemented with other systems.

The illustrated method 500 begins as the original HTML 502 and the image sections 504 of an email are loaded into the HTML engine 122 of the campaign manager 120. The HTML engine 122 then finds 506 each image section using a stored reference to individual or multiple HTML tags (e.g., CSS selector, Xpath, XSLT, etc.). The HTML engine 122 then replaces 508 each image tag source (i.e., src) with a dynamic URL, which includes a section identifier and an experiment identifier. The section identifier refers to the image section of the email message. The experiment identifier refers to the email campaign to which this email belongs. The HTML engine 122 then finds 510 all of the links and image maps and replaces 512 each hyperlink reference (i.e., href) in the link and image areas with a tracking link. The HTML engine 122 then outputs 514 the modified HTML. The depicted method 500 then ends.

FIG. 9 depicts a flow chart diagram of one embodiment of a method 540 for generating modified variable HTML with static images. While embodiments of the method 540 may be implemented in conjunction with the email campaign system 100 of FIG. 1 and the campaign manager 120 of FIG. 2A, other embodiments of the method 540 may be implemented with other systems.

The illustrated method 540 is similar to the method 500 shown in FIG. 8 and described above, with the following exceptions. The method 540 uses both the original HTML 542 and the specified combinations. The HTML engine 122 uses these and loads 544 image sections and specific variations of these sections. The HTML engine 122 then finds 546 each section using a stored reference to individual or multiple HTML tags (e.g., CSS selector, Xpath, XSLT, etc.). The HTML engine 122 then modifies 548 each section using stored parameters (e.g., replace image source, replace text, modify styling, etc.). The HTML engine 122 then finds 510 all of the links and image maps and replaces 512 each hyperlink reference (i.e., href) in the link and image areas with a tracking link. The HTML engine 122 also may append 554 a tracking pixel. The HTML engine 122 then outputs 516 the modified HTML. The depicted method 540 then ends.

An embodiment of the email campaign system 100 described herein includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc. Other embodiments may utilize interpreted software and scripting languages.

Further embodiments of the invention can be implemented in a cloud computing environment, or other networked environment, in which software is delivered as a service over the internet, or other network, for access by users via a web browser or other thin client. This delivery method is sometimes referred to as software-as-a-service (SaaS). Such implementations provide capability to a consumer to use a provider's software applications running on a cloud infrastructure, which may facilitate accessibility from a variety of client interfaces. In some embodiments, the consumer does not own, manage, control, or maintain the underlying system hardware beyond the client machine, but may control a particular deployment of the application. Utilizing shared processing and/or storage resources can facilitate faster update cycles, more seamless application transitions, and lower consumer costs.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An email campaign management system comprising:
an HTML engine to receive input email content and to generate modified email content from the input email content, wherein the modified email content includes at least one image location;
an image gateway to dynamically associate an image with the image location at a time that an email message inclusive of the image location is opened by a recipient; and
an activity monitor to track a user selection of a hyperlink within the email message inclusive of the image location and the associated image.

2. The email campaign management system of claim 1, wherein the modified email content generated by the HTML engine comprises a plurality of image and/or text locations, and the campaign manager is further configured to dynamically associate different combinations of images and/or text with the image and/or text locations for different recipients of the email message.

3. The email campaign management system of claim 2, wherein the activity monitor is further configured to track different user selections from the different recipients and to associate the different user selections with the different combinations of images received by the different users.

4. The email campaign management system of claim 2, wherein the image gateway is further configured to facilitate user selections of authorized image combinations and prohibited image combinations for use in the different combinations of images.

5. The email campaign management system of claim 1, wherein the HTML engine is further configured to generate an email message HTML inclusive of a plurality of distinct image and/or text locations.

6. The email campaign management system of claim 5, further comprising an email composer coupled to the HTML engine, wherein the email composer facilitates user actions to arrange the plurality of distinct image and/or text locations relative to other content of the email HTML.

7. The email campaign management system of claim 5, further comprising a combination simulator coupled to the email composer, wherein the combination simulator generates a plurality of visual preview representations of the email message HTML with various combinations of HTML at the distinct HTML locations.

8. The email campaign management system of claim 1, wherein the image gateway is further configured to redirect an email viewer of the recipient to an image retrieval location to retrieve the image associated with the image location.

9. An email campaign management system comprising:
an HTML engine to receive input email content and to generate modified email content from the input email content, wherein the modified email content includes at least one image location;
a content gateway to associate content with a section of an email at a time that an email message is generated for a particular recipient; and
an activity monitor to track a user selection of a hyperlink within the email message inclusive of the image location and the associated image.

10. The email campaign management system of claim 9, wherein the content gateway is further configured to insert a selected image and/or text variation into the email message based on at least one market segment characteristic of the recipient.

11. The email campaign management system of claim 9, wherein the content gateway is further configured to associate a selected image with an image section of the email prior to transmission of the email to the recipient.

12. The email campaign management system of claim 9, wherein the content gateway is further configured to associate a selected text variation with a text section of the email prior to transmission of the email to the recipient.
